(19) United States
(12) Patent Application Publication
(10) Pub. No.: US 2026/0087535 A1
(43) Pub. Date: Mar. 26, 2026

(54) RESETTING RECOMMENDATIONS WHILE MAINTAINING PROFILE AND MATCHES

(71) Applicant: MATCH GROUP, LLC, Dallas, TX (US)

(72) Inventors: Michelle Parsons, New York, NY (US); Jasjit Mangat, Brooklyn, NY (US); Christopher Paniati, Oakland, CA (US); Mitch LaPoff, Brooklyn, NY (US); Quinn Hoang, Brooklyn, NY (US)

(73) Assignee: Hinge, Inc., (US)

(21) Appl. No.: 19/111,614

(22) PCT Filed: Sep. 12, 2023
(86) PCT No.: PCT/US23/32502

§ 371 Date: Mar. 13, 2025

Related U.S. Application Data
(60) Provisional application No. 63/407,295, filed on Sep. 16, 2022.

(51) Int. Cl. G06Q 30/0601

(52) U.S. Cl. CPC G06Q 30/0631

(57) ABSTRACT

A method includes forming a first recommendation, for a first user of a networking site, of a second user of the networking site, at least in part based on a first profile of a first account of the first user on the networking site and a second profile of a second account of the second user on the networking site; performing a first interaction between the first account and the second account; receiving a request to reset the first profile; producing an updated profile by maintaining a first portion of the first profile and resetting a second portion of the first profile; and forming a second recommendation, for the first user, of the second user, at least in part based on the updated profile.

### CROSS-REFERENCE TO RELATED APPLICATIONS

This application claims priority to US Provisional App. Ser. No. 63/407,295, filed Sep. 16, 2022, entitled “RESETTING RECOMMENDATIONS WHILE MAINTAINING PROFILE AND MATCHES.” The entire contents of that application are herein incorporated by reference in their entirety.

### BACKGROUND

### Technical Field

This disclosure relates to online matching systems in which users interact, and particularly to resetting at least a portion of a profile on such a system.

### Related Art

Online networking sites (e.g., applications or websites) match one entity (e.g., user) with another entity. For example, one online networking site might match prospective romantic partners. Another online networking site might match potential employers with potential employees.

To promote networking, sites sometimes recommend users to each other. However, users sometimes grow dissatisfied with their recommendations by the online networking sites. For example, users sometimes go through personal change (e.g., begin seeking more committed relationships) and look to modify their recommendations from the networking site. Therefore, to reset these recommendations, users sometimes delete their accounts with the intention of creating new accounts.

In addition, some networking sites promote (e.g., boost) the profiles of new users to increase potential matching opportunities for the new users. Thus, a user might delete their account and create a new account to take advantage of this promotion.

### BRIEF SUMMARY

In a first implementation, a method includes forming a first recommendation, for a first user of a networking site, of a second user of the networking site, at least in part based on a first profile of a first account of the first user on the networking site and a second profile of a second account of the second user on the networking site; performing a first interaction between the first account and the second account; receiving a request to reset the first profile; producing an updated profile by maintaining a first portion of the first profile and resetting a second portion of the first profile; and forming a second recommendation, for the first user, of the second user, at least in part based on the updated profile.

A second implementation is the first implementation, wherein the first interaction is defined by the first user skipping the second profile.

A third implementation is any of the first and second implementations, further comprising: performing a second interaction between the first account and the second account, wherein the first interaction is defined by the first user sending a like regarding at least a portion of the second profile, and the second interaction is defined by the second user rejecting the like.

A fourth implementation is any of the first through third implementations, further comprising: performing a second interaction between the first account and the second account, wherein the first interaction is defined by the second user sending a like regarding at least a portion of the first profile, and the second interaction is defined by the first user rejecting the like.

A fifth implementation is any of the first through fourth implementations, wherein the first portion includes at least one photograph of the first user.

A sixth implementation is any of the first through fifth implementations, further comprising: updating the first profile with a third portion, wherein the second recommendation is at least in part based on the third portion.

A seventh implementation is any of the first through sixth implementations, further comprising: promoting the updated profile on the networking site.

In an eighth implementation, a non-transitory, computer-readable medium is encoded with executable instructions that, when executed by a processing unit, perform operations comprising: forming a first recommendation, for a first user of a networking site, of a second user of the networking site, at least in part based on a first profile of a first account of the first user on the networking site and a second profile of a second account of the second user on the networking site; performing a first interaction between the first account and the second account; receiving a request to reset the first profile; producing an updated profile by maintaining a first portion of the first profile and resetting a second portion of the first profile; and forming a second recommendation, for the first user, of the second user, at least in part based on the updated profile.

A ninth implementation is the eighth implementation, wherein the first interaction is defined by the first user skipping the second profile.

A tenth implementation is the eighth or ninth implementation, the operations further comprising: performing a second interaction between the first account and the second account, wherein the first interaction is defined by the first user sending a like regarding at least a portion of the second profile, and the second interaction is defined by the second user rejecting the like.

An eleventh implementation is any of the eighth through tenth implementations, the operations further comprising: performing a second interaction between the first account and the second account, wherein the first interaction is defined by the second user sending a like regarding at least a portion of the first profile, and the second interaction is defined by the first user rejecting the like.

A twelfth implementation is any of the eighth through eleventh implementations, wherein the first portion includes at least one photograph of the first user.

A thirteenth implementation is any of the eighth through twelfth implementations, the operations further comprising: updating the first profile with a third portion, wherein the second recommendation is at least in part based on the third portion.

A fourteenth implementation is any of the eighth through thirteenth implementations, the operations further comprising: promoting the updated profile on the networking site.

In a fifteenth implementation, an apparatus includes a processor configured to form a first recommendation, for a first user of a networking site, of a second user of the networking site, at least in part based on a first profile of a first account of the first user on the networking site and a second profile of a second account of the second user on the networking site, and to perform a first interaction between the first account and the second account; and a network interface that receives a request to reset the first profile, wherein the processor further is configured to produce an updated profile by maintaining a first portion of the first profile and resetting a second portion of the first profile and to form a second recommendation, for the first user, of the second user, at least in part based on the updated profile

A sixteenth implementation is the fifteenth implementation, wherein the first interaction is defined by the first user skipping the second profile.

A seventeenth implementation is the fifteenth or sixteenth implementation, wherein the processor further is configured to perform a second interaction between the first account and the second account, the first interaction is defined by the first user sending a like regarding at least a portion of the second profile, and the second interaction is defined by the second user rejecting the like.

An eighteenth implementation is the any of the fifteenth through seventeenth implementations, wherein the processor further is configured to perform a second interaction between the first account and the second account, the first interaction is defined by the second user sending a like regarding at least a portion of the first profile, and the second interaction is defined by the first user rejecting the like.

A nineteenth implementation is any of the fifteenth through eighteenth implementations, wherein the first portion includes at least one photograph of the first user.

A twentieth implementation is any of the fifteenth through nineteenth implementations, wherein the processor further is configured to update the first profile with a third portion, and the second recommendation is at least in part based on the third portion.

A twenty-first implementation is any of the fifteenth through twentieth implementations, wherein the processor further is configured to promote the updated profile on the networking site.

In a twenty-second implementation, an apparatus includes means for forming a first recommendation, for a first user of a networking site, of a second user of the networking site, at least in part based on a first profile of a first account of the first user on the networking site and a second profile of a second account of the second user on the networking site; means for performing a first interaction between the first account and the second account; means for receiving a request to reset the first profile; means for producing an updated profile by maintaining a first portion of the first profile and resetting a second portion of the first profile; and means for forming a second recommendation, for the first user, of the second user, at least in part based on the updated profile.

A twenty-third implementation is the twenty-second implementation, wherein the first interaction is defined by the first user skipping the second profile.

A twenty-fourth implementation is the twenty-second or twenty-third implementation, further comprising: means for performing a second interaction between the first account and the second account, wherein the first interaction is defined by the first user sending a like regarding at least a portion of the second profile, and the second interaction is defined by the second user rejecting the like.

A twenty-fifth implementation is any of the twenty-second through twenty-fourth implementations, further comprising: means for performing a second interaction between the first account and the second account, wherein the first interaction is defined by the second user sending a like regarding at least a portion of the first profile, and the second interaction is defined by the first user rejecting the like.

A twenty-sixth implementation is any of the twenty-second through twenty-fifth implementations, wherein the first portion includes at least one photograph of the first user.

A twenty-seventh implementation is any of the twenty-second through twenty-sixth implementations, further comprising: means for updating the first profile with a third portion, wherein the second recommendation is at least in part based on the third portion.

A twenty-eighth implementation is any of the twenty-second through twenty-seventh implementations, further comprising: means for promoting the updated profile on the networking site.

### BRIEF DESCRIPTION OF THE SEVERAL VIEWS OF THE DRAWINGS

FIG. 1 depicts a flow in which a user of a networking site deletes and creates a new profile on the networking site.

FIG. 2 depicts an algorithm for a recommendation reset system, according to one implementation of the present disclosure.

FIG. 3 depicts a typical flow in which a like from one user is rejected by another user of a networking site.

FIG. 4 depicts an algorithm for a recommendation reset system after a like is declined, according to one implementation of the present disclosure.

FIG. 5 depicts an algorithm for skipping a profile, according to one implementation of the present disclosure.

FIG. 6 depicts a computing device, according to various implementations of the present disclosure.

### DETAILED DESCRIPTION

For purposes of illustrating the present innovation, it might be useful to understand phenomena relevant to various implementations of the disclosure. The following foundational information can be viewed as a basis from which the present disclosure can be explained. Such information is offered for purposes of explanation only and, accordingly, should not be construed to limit the scope of the present disclosure and its potential applications.

Some online dating sites request that a user complete a profile that can summarize attributes of the user and attributes of potential matches for the user. These profiles can include a significant amount of information, such as pictures, videos, voice prompts, demographic information (e.g., age, religion), and open answers. Based on such information, the online dating site can recommend a potential match to the user.

On some online dating sites, the user (also called a “searcher”) can express interest in the potential match (also called a “subject”) via a “like,” “heart,” etc. After the user and the potential match express mutual interest, the user and the potential match are “matched.” On many networking sites, establishing a match is a prerequisite to open communication between users.

To distinguish between general interest in a potential match and a particular interest in the potential match, some dating sites offer a premium tier of interest, which can include a Super Like™ or “rose” feature, for example. If the user sends the potential match a premium indicator of interest, then the dating site might prioritize matching the user to the potential match. For example, the dating site can prioritize showing the user's profile to the potential match, upon the potential match's next login to the dating site.

If the user is not interested in a subject, the user can pass on the subject. In some cases, this pass might be considered a skip, a rejection, or simply not acting on the subject within a predetermined period of time. To retain the user's interest, the dating site will refrain from showing the profile of the subject to the user again, unless some trigger occurs. Such a trigger might be, for example, viewing profiles of all potential matches within a particular area, an expiration of a predetermined period of time (e.g., one year), or an action by the user.

Some dating sites allow users to undo a pass, if an undo instruction is given within a predetermined period of time (e.g., five seconds). Other dating sites offer a premium feature in which the user can undo the pass, upon payment of a fee.

To maintain sustained interest in the dating site over time, many dating sites throttle a user's amount of interaction within the dating site within one or more predetermined periods of time. For example, a site can limit the number of profiles provided to the user within an 8-hour period. As another example, a site can limit the number of likes sent by the user within a 24-hour period.

To avoid user discomfort, some networking sites allow a searcher to report a subject (or, indeed, a subject to report a searcher) for inappropriate behavior, such as harassment. Similarly, some networking sites allow a searcher to remove particular subjects from their potential matches. For example, a searcher might wish to remove a relative, coworker, friend, or previous romantic partner from their potential matches. Further, some networking sites allow a searcher to unmatch from a potential match if there is not mutual interest in maintaining the match.

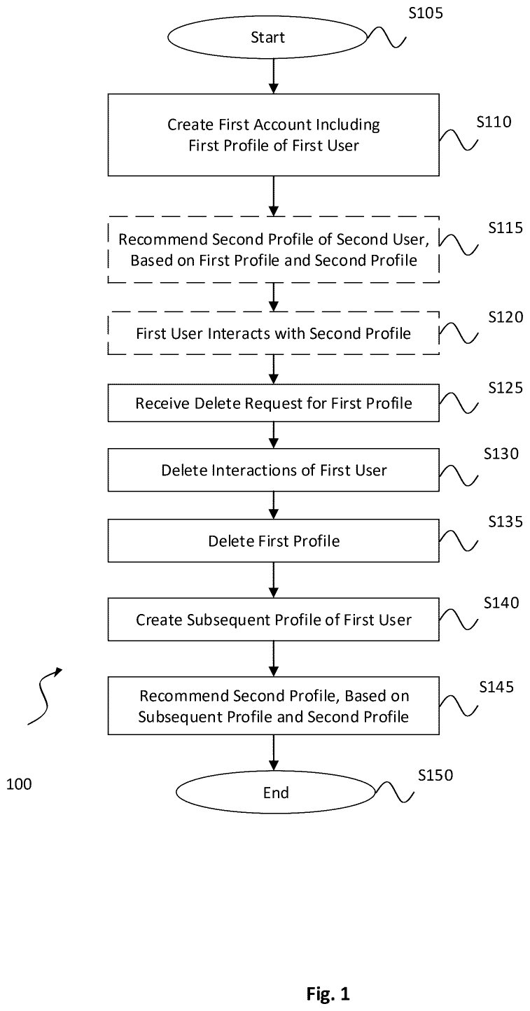

To reset passes, a searcher might delete his or her account. FIG. 1 depicts a flow 100 in which a user deletes their profile and creates a new profile on the networking site. The flow 100 begins at S105 and advances to S110.

In S110, a first user (e.g., the searcher) of the networking site creates his or her account including a first profile. The profile can include, for example, photographs of the searcher. The profile also can include romantic interests of the searcher, as well as hobbies of the searcher. On some networking sites, the profile can also include demographic information of the searcher. The flow 100 then advances to S115.

In S115, the networking site optionally recommends a profile of another user (e.g., the subject) to the searcher. This recommendation is based on the profile of the searcher and the profile of the subject. The flow 100 then advances to S120.

In S120, the searcher optionally interacts with the profile of the subject. For example, this interaction can include adversely rating the profile of the subject, skipping the profile of the subject, or declining a potential match with the profile of the subject. On some networking sites, this interaction can be defined by the searcher not interacting with the profile of the subject within a predetermined period of time.

Regardless of the optional interaction at S120, the searcher decides to delete his or her profile on the networking site. The flow 100 then advances to S125.

In S125, the networking site receives a delete request from the searcher to delete his or her profile. The flow 100 then advances to S130.

In S130, the networking site deletes all interactions by the searcher with the networking site. For example, the actions can include actions with subjects, such as the interaction performed in S120. The flow 100 then advances to S135.

In S135, the networking site deletes the profile of the searcher. The flow 100 then advances to S140.

The searcher then decides to create a new profile on the networking site. The flow 100 subsequently advances to S140.

In S140, the searcher creates a subsequent profile. This subsequent profile effectively includes recreating the profile of the searcher. Thus, the searcher uploads photographs and indicates his or her romantic interests, hobbies, and demographic information. The flow 100 then advances to S145.

In S145, the networking site recommends the profile of the subject to the searcher. This recommendation is based on the subsequent profile of the searcher created in S140 and the profile of the subject. The flow 100 then advances to S150.

In S150, the flow 100 concludes.

Disadvantageously, the subsequent profile in S140 will not have access to the previous data of the searcher. This inability to access the previous data is particularly clear in, but not confined to, the situation in which the first user deletes their account. In that situation, the first user loses all previous conversations they had with other users with whom the first user matched.

Thus, the searcher might consider all their previous data, such as the searcher's existing matches and previous profile, lost.

Creating an account can consume a lot of time for the searcher to go through an onboarding process. Thus, not all users who delete their account create a new account, negatively impacting user retention. Further, daters have little to no control over their recommendations, and currently have no other option to control their recommendations, aside from deleting their account and starting over.

Users desire to keep their profile and matches while resetting their recommendations. Thus, select implementations of the present disclosure can achieve a time savings and user control of this process.

The present disclosure offers users the ability to reset their recommendations without having to create a new profile and lose their matches and incoming likes. That is, the user can retain their matches and likes. Various implementations allow users to have some control over their recommendations without having to start all over and lose valuable information on their account.

Various implementations of the present disclosure can clear history for the searcher in a networking site feed as it relates to their previous likes and skips, so they have an opportunity to revisit profiles of other users.

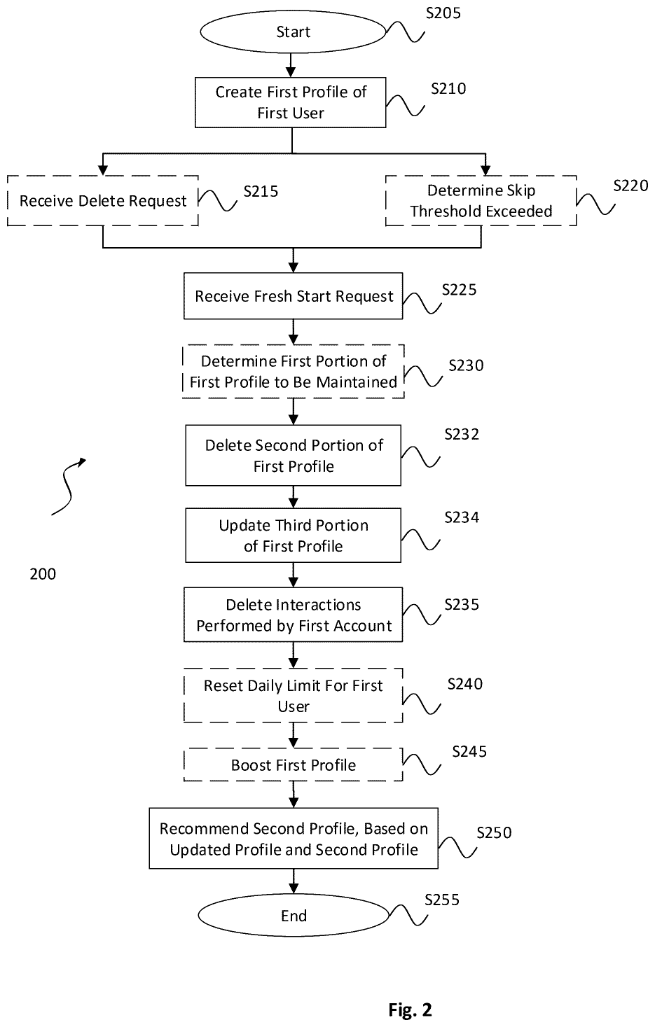

FIG. 2 depicts an algorithm 200 for a high-level flow of the recommendation reset system, according to one implementation of the present disclosure. The algorithm 200 begins at S205 and advances to S210.

In S210, a first user (e.g., the searcher) of the networking site creates his or her account including a first profile, as in S110. The algorithm 200 then advances to S215, S220, or S225.

In S215, the networking site optionally receives a delete request from the searcher to delete his or her account. Thus, some implementations of the algorithm suggest an adjustable reset as an alternative to the searcher deleting their account. The algorithm 200 then advances to S225.

Alternatively, in S220, the networking site optionally determines that a skip threshold has been exceeded. In one implementation, the skip threshold is defined by the searcher skipping a predetermined number of consecutive profiles (e.g., five profiles in a row). In another implementation, the skip threshold is defined by the searcher skipping a predetermined number of profiles within a predetermined time period (e.g., 50 profiles in a day). In yet another implementation, the skip threshold is defined by the searcher skipping a predetermined percentage of potential matches within a particular area (e.g., 20% of the potential matches within the geographic distance preferred by the searcher). Thus, some implementations suggest a profile reset based on a perception of dissatisfaction on the part of the searcher. Thus, the networking site can offer a profile reset to retain user engagement. The algorithm 200 then advances to S225.

In S225, the matching system receives a request for a profile reset (e.g., a “fresh start”) from the searcher. This request can be itself a response to the reset offering described in connection with S215 or S220. In some implementations, the searcher simply can request a reset as a feature of the networking site. The algorithm 200 then advances to S230.

In S230, the networking site determines a first portion of the profile of the searcher to be maintained. In some implementations, this first portion of the profile includes immutable data, such as a birthdate of a user. In select implementations, this portion of the profile includes geographic data, because changing a location (e.g., moving one's home) does not implicate creating a new profile or account.

Thus, in the case of infrequently changed demographics (e.g., gender and religion), the networking site does not necessarily request the searcher re-enter this information. On the other hand, for those searchers who do change their gender or religion, it remains possible to use the reset effectively. Indeed, with a profile reset, it can be possible to update any portion of the user's profile, apart from information that the service provider determines should not be changeable, such as the user's birthdate.

The algorithm 200 then advances to S232.

In S232, the networking site deletes a second portion of the first profile. In various implementations, the networking site prompts the user for an input identifying which portions of the first profile the searcher would like to designate as the second portion (e.g. reset). The algorithm then advances to S234.

In S234, the networking site optionally updates a third portion of the first profile, based on information received from the first user. The third portion can include the second portion of the profile. For example, if a prompt states, “Weekly alcohol consumption,” then the second portion of the profile could be “more than 14 drinks.” If the user decreases their alcohol consumption over time, then the third portion of the profile could be “between 3 and 7 drinks.”

Thus, in the case of flexible demographic information (e.g., the amount of relationship commitment desired by the user, the regularity with which the searcher consumes alcohol), the networking site can allow the searcher to update this information when performing the profile reset.

The third portion is not limited to including the second portion of the profile. For example, the searcher might have declined to answer a previous prompt (such as “wants children?”), but now has a definitive answer.

The algorithm 200 then advances to S235.

Thus, the networking site can produce an updated profile of the first user, based on maintaining the first portion of the first profile, deleting the second portion of the first profile, and/or updating the third portion of the first profile.

In S235, the networking site optionally deletes interactions performed by the searcher. These interactions can include, for example, sending skips, sending and/or receiving likes, and sending ratings of other profiles on the networking site. Thus, the first user can again interact with the second profile via a skip, sending or receiving a like, and/or sending a rating of the second profile.

In some implementations, the system does not reset a like, when the searcher sent a subject the like and the subject has not responded yet. Thus, the searcher stays in the subject's “Likes You” list. Similarly, some implementations of the system do not reset a like, when the subject sends the searcher a like, and the subject has not responded. These subjects will stay in the searcher's “Likes You” tab, for example.

Many implementations do not reset particular actions. For example, if the searcher received a like and no response to the like has occurred, there is no response to be reset. Of course, some implementations can reset the sending of the like by the other account. This reset can be particularly worthwhile in implementations in which machine-learning considers the sending of likes, because the other user might no longer like the updated profile of the searcher.

Select implementations do not reset actions to preserve searcher comfort. For example, if a searcher reports a subject for inappropriate behavior, then the networking site can maintain (i.e., not reset) such a report to prevent the searcher from encountering the subject again. Similarly, if a searcher skips a subject, then particular implementations can maintain (i.e., not reset) such a skip. Likewise, if a searcher unmatches from a subject, then various implementations can maintain (i.e., not reset) such an unmatching. Of course, some implementations permit a reset of unmatching, as well as other actions. The algorithm 200 then advances to S240.

In S240, the networking site optionally can reset a daily limit for the searcher. After beginning their reset, the searcher might seek new potential matches. Thus, to avoid frustration on the part of the searcher, the networking site can reset a daily limit of likes (e.g., 10). Similarly, the networking site can reset a daily limit of activity points or any other limited feature (e.g., “beans”). The algorithm 200 then advances to S245.

In S245, the networking site can boost the profile of the searcher. For example, the networking site can increase the likelihood with which the profile of the searcher appears to other users. In some implementations, the networking site can increase the number of appearances of the profile of the searcher to other users. The networking site also can prioritize the appearance of the profile of the searcher to other users. Thus, the networking site can publicize the updated profile of the searcher. Such a profile boost can be similar to the treatment performed by some networking sites to highlight a new user, or it may be a modification of that treatment, to prioritize the searcher over some other users. A reset can provide users with a profile highlight and wipe away their previous decisions (with a few exceptions) in hopes that the user gets better recommendations and, ultimately, is now more likely to find a meaningful connection. The algorithm 200 then advances to S250.

In S250, the networking site can form a recommendation of a profile of a subject to the searcher. This recommendation can be based on the updated profile of the searcher, and the profile of the subject.

In particular, the networking site can form a recommendation of a profile of a subject who the searcher previously skipped or from whom the searcher declined a like. In some implementations, the subject can be a user who declined a like from the searcher. The algorithm 200 then advances to S255.

In S255, the algorithm 200 concludes.

In the example of FIG. 2, profile reset prompts were generated at S215 and S220, leading to a fresh start request in S225. In at least one implementation, the system can generate the profile reset prompt, in response to the user changing a predetermined number of photographs, prompt responses, and/or preferences. In at least one other implementation, the system can generate the profile reset prompt, in response to the user changing a predetermined percentage of the content of the prompt responses and/or preferences within a predetermined period of time.

In some implementations, the reset request in S255 additionally or alternatively can be received based on display of a profile feed on the networking site and/or based on a profile edit request.

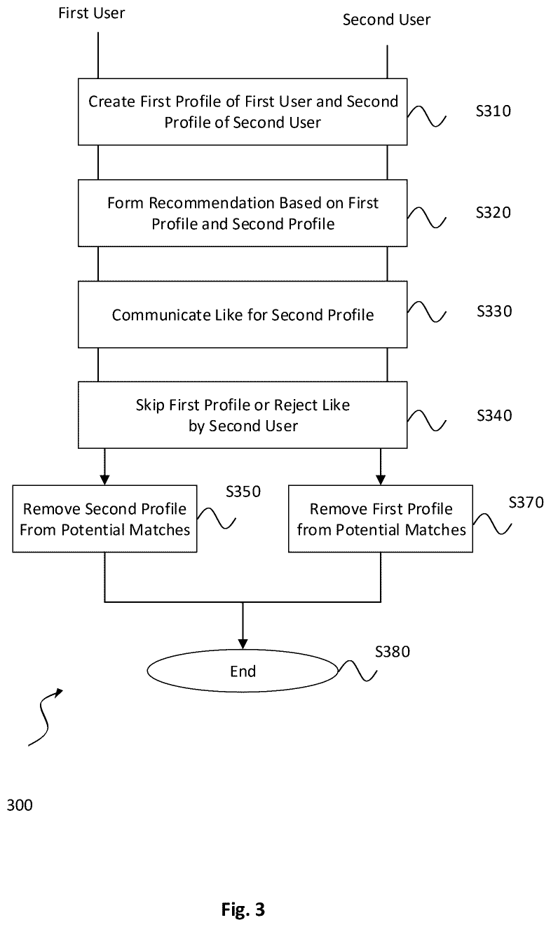

FIG. 3 depicts a typical flow 300 in which a like from one user is rejected by another user of a networking site.

The flow 300 begins at S310 in which the first profile of a first user and a second profile of a second user are created on the networking site. The flow 300 then advances to S320.

In S320, the networking site forms a recommendation for at least one of the first user or the second user, based on the first profile and the second profile created at S310. For example, the recommendation visually displays at least a portion of the second profile to the first user (e.g., the searcher). The networking site can visually display the portion of the second profile in any context including a “discover” tab or a “standout” tab. The networking site can send a push notification to the user to announce the recommendation. The push notification additionally or alternatively can include an audio notification or a haptic notification. The flow 300 then advances to S330.

In S330, the networking site communicates a like sent from the first user to the second user. The flow 300 then advances to S340.

In S340, the second user rejects the like sent by the first user or skips the first profile. In some implementations, the networking site notifies the second user of the like, and the second user affirmatively declines the like. In other implementations, the second user effectively can decline the like without expressly addressing the like, e.g., by letting a predetermined period of time (such as 24 hours) expire. In addition, the second user might skip the first profile, after the networking site has displayed the second profile to the first user but before the first user has sent the like.

Once the second user skips the first profile or rejects the like, the networking site does not match the first user and the second user. The flow 300 then advances to S350 and S370.

In S350, the networking site removes the second profile from the potential matches for the first user. This removal can be temporary until a predetermined condition occurs, such as a passage of a period of time or payment of a fee by the first user. The flow 300 then advances to S380.

In S370, the networking site removes the first profile from the potential matches for the second user. This removal can be temporary until a predetermined condition occurs, such as a passage of a period of time or payment of a fee by the second user. The flow 300 then advances to S380.

In S380, the flow 300 concludes.

The subject matter of FIG. 3 is described from the perspective of the first user being the searcher and the second user being the subject. In many implementations, the subject matter of FIG. 3 is equally applicable from the perspective of the second user being the searcher, and the first user being the subject. Thus, regardless of whether the first user rejects the like of the second user or the second user rejects the like of the first user, the networking site can remove the second profile from the potential matches of the first user.

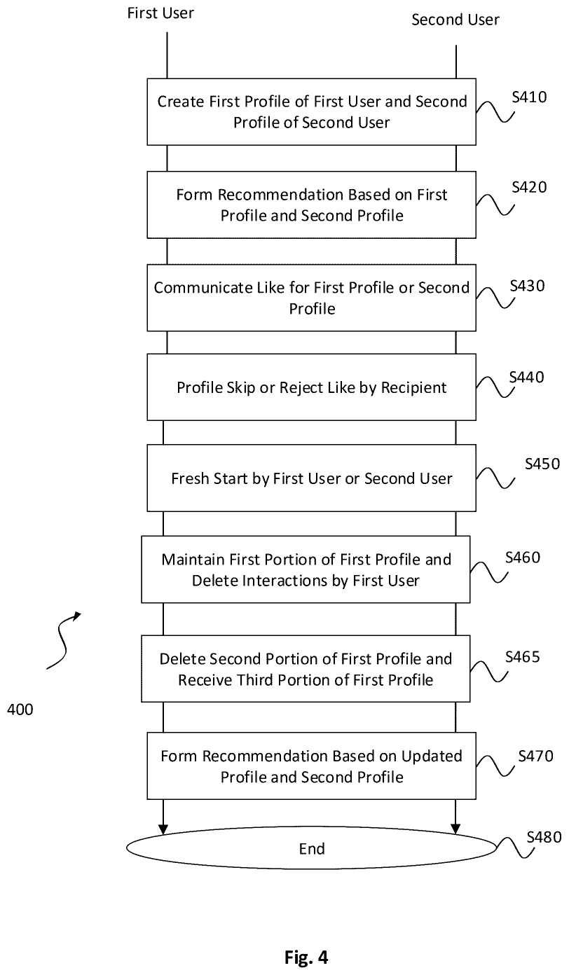

FIG. 4 depicts an algorithm 400 for a recommendation reset system after a like is declined, according to one implementation of the present disclosure. This figure shows one example implementation in which a first user saw a recommended profile of a second user or the second user liked them, and the first user skipped the profile of the second user. Then, the first user performs a profile reset. In this case, the networking site gives the first user the opportunity to revisit the profile of the second user.

The algorithm 400 begins at S410 in which the networking site creates a first profile of a first user and a second profile of a second user, as in S310. The flow 400 then advances to S420.

In S420, the networking site forms a recommendation for at least one of the first user or the second user, based on the first profile and the second profile created at S410. The algorithm 400 then advances to S430.

In S430, the networking site communicates a like sent from the first user to the second user. Alternatively, the networking site communicates a like sent from the second user to the first user. The algorithm 400 then advances to S440.

In S440, the second user skips the first profile or rejects the like, in the case that the like was sent by the first user. Alternatively, the first user skips the second profile or rejects the like, in the case that the like was sent by the second user. The algorithm 400 then advances to S450.

In S450, the first user requests a profile reset (e.g., “Fresh Start”), and the networking site performs the reset procedure. With the profile reset, the first user can revisit people already skipped or rejected. The algorithm 400 then advances to S460.

In S460, the networking site maintains a first portion of the first profile and deletes actions by the first user. In some implementations, the networking site deletes a second portion of the first profile. As discussed previously, the networking site also can maintain some actions by the first user, such as reports, removals, and unmatches. The algorithm 400 then advances to S465.

In S465, the networking site receives from the first user an update to a third portion of the first profile. Again, the third portion can include the second portion. For example, the second portion can be the first user's previous drinking habits, and the third portion can be the first user's current drinking habits. The algorithm 400 then advances to S470.

Thus, the networking site can produce an updated profile at least in part based on the maintenance of the first portion, the deletion of the second portion, and the update of the third portion.

In S470, the networking site forms a recommendation for the first user of the second user, at least in part based on the updated profile and the second profile. The networking site can form such a recommendation, despite the like rejected by the recipient in S440. Similarly, the networking site can form a recommendation for the second user, based on the updated profile and the second profile. The algorithm 400 then advances to S480.

In S480, the algorithm 400 concludes.

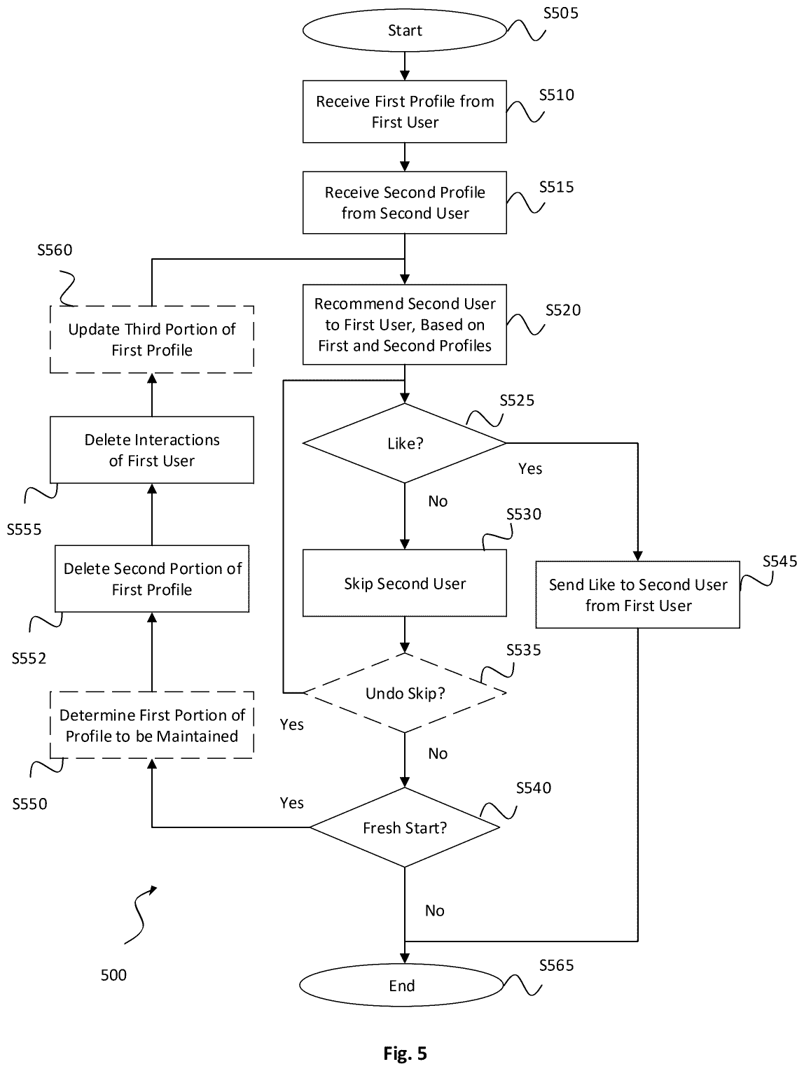

FIG. 5 depicts an algorithm 500 for skipping a profile, according to one implementation of the present disclosure.

The algorithm 500 begins at S505 and advances to S510.

In S510, the networking site creates a first account for a first user. In the example of FIG. 5, the first user is the searcher. The networking site creates, within the first account, a first profile for the first user. The networking site can receive, from the first user, photographs of the first user to be included in the first profile. The networking site also can receive, from the first user, information for the first profile, including demographic information of the first user and romantic goals of the first user. The algorithm 500 then advances to S515.

In S515, the networking site creates a second account for a second user. In the example of FIG. 5, the second user is the subject. The networking site creates, within the second account, a second profile for the second user. The networking site can receive, from the second user, photographs of the second user to be included in the second profile. The networking site also can receive, from the second user, information for the second profile, including demographic information of the second user and romantic goals of the second user. The algorithm 500 then advances to S520.

In S520, the networking site forms a recommendation of the second user for the first user, at least in part based on the first profile and the second profile. The recommendation can cause a display of at least a portion of the second profile to the first user. The algorithm 500 then advances to S525.

In S525, the networking site receives, from the first user, an indication whether the first user would like to match with the second user. If the first user would like to match with the second user, then the indication can be a like or a message, for example. If the first user would not like to match with the second user, then the indication can be a skip, for example.

If the indication indicates the first user would not like to match with the second user, then the algorithm 500 advances to S530.

If the indication indicates the first user would like to match with the second user, then the algorithm 500 advances to S545.

In S530, the networking site skips the second user. For example, the networking site can cause a display of at least a portion of a third profile of a third user to the first user. The algorithm 500 then advances to S535.

In S535, the networking site optionally can receive an undo indication from the first user. Some networking sites, such as Hinge® by Hinge Inc., owned by Match Group, allow the first user the opportunity to undo the skip, in response to a request within a predetermined period of time. Other networking sites, such as Tinder®, also owned by Match Group, allow premium users the opportunity to undo a skip.

If the undo indication indicates the first user would like to undo the skip of the second user, then the algorithm 500 returns to S525.

If the undo indication indicates the first user would not like to undo the skip of the second user (or if S535 is not performed), then the algorithm 500 advances to S540.

In S540, the networking site determines whether to perform the profile reset (e.g., “Fresh Start”) for the first user, based on a reset indication received from the first user.

If the networking site determines to perform the profile reset for the first user, then the algorithm 500 advances to S550.

If the networking site determines not to perform the profile reset, then the algorithm 500 advances to S545.

In S550, the networking site optionally determines to maintain a first portion of the first profile. The first portion of the first profile can be, for example, photographs of the first user or a portion unlikely to change (e.g., gender or religion). In some implementations, this determination is at least in part based on an input received from the first user.

Further, in S552, the networking site can delete a second portion of the first profile. The second portion can be, for example, an amount of relationship commitment or a frequency at which the first user consumes alcohol. The algorithm 500 then advances to S555.

In S555, the networking site deletes interactions of the first user. In particular, the networking site deletes the skip performed in S530. In some implementations, this deletion occurs only relative to a matching algorithm: the networking site can retain a record of the skip, even though the matching algorithm will not consider the skip. The networking site can retain some actions of the first user, such as existing matches and/or messages. The algorithm 500 then advances to S560.

In S560, the networking site optionally determines to update a third portion of the first profile. The third portion can include at least a portion of the second portion. Thus, the first user can indicate a new amount of alcohol consumption or amount of relationship commitment. The algorithm 500 then advances to S520, in which a recommendation is performed at least in part based on the first profile, as modified by the deletion of the second portion and/or update of the third portion.

Returning to the match in S525, the algorithm can advance to S545, in which the matching system sends a like to the second user from the first user. The algorithm 500 then advances to S565.

In S565, the algorithm 500 concludes.

The process of deleting and recreating an account is time consuming and often overwhelming. This process can involve uploading several photos and answering prompts, which can take several minutes and a lot of user energy. So, the user has put in all this investment to set up their initial profile and expects a high return. With a reset, users do not have to go back through this lengthy process to achieve their desired results.

Many implementations can respect specific interactions. That is, in such implementations, although some interactions of the searcher and a subject can be reset, the networking site does not reset these specific interactions. Specifically, to protect user safety, the networking site might not reset a previous report, removal, or unmatch of a subject by a searcher or of the searcher by the subject. The networking site might not reset an interaction in which the searcher sent a positive rating (e.g., like or rose), and the subject has not rated the searcher back yet. The networking site might not reset an interaction in which the searcher previously sent or received a positive rating (e.g., like or rose), and the subject accepted, as this would result in a match that is maintained by several implementations.

On the other hand, resetting or deleting the interactions can include receiving a positive rating (e.g., like or rose) from a subject, and rejecting the positive rating. In such a case, both the searcher and the subject can see each other again, after the profile reset.

Select implementations delete all previous positive ratings (e.g., likes or roses) sent by the searcher, including those ratings that have not yet been replied to by the subject. Some implementations maintain the ratings that have not yet been replied to.

In some implementations, resetting/deleting the interactions can delete the searcher's matches including, but not limited to, the second user. However, as noted previously, some other implementations maintain these matches.

Resetting the profile can include resetting data on how the searcher's profile is performing, and giving recommendations on how to improve it before/during the searcher's profile reset. As one example, some networking sites can indicate a searcher's top-performing photograph, as discussed in U.S. Pat. No. 9,715,532, assigned to Match Group, LLC, and incorporated by reference herein in its entirety. The networking site can recommend that the searcher consider making it his or her first photograph. Thus, implementations of the present disclosure can provide such a recommendation during or after the profile reset.

Resetting the profile can include updating the machine learning underlying the networking site, based on the deleted actions, such as by resetting previous outputs by the machine learning algorithm. Resetting the profile also can include directing the searcher to update his or her profile to make the most of their new experience once the reset process is initiated.

Some networking sites generally do not show a searcher the subjects who have already rejected the searcher. As noted above, the system might show such subjects to the searcher, upon the searcher's reset. However, the system might not show the searcher to that subject, under such a circumstance. If the system shows the rejecting subject to the searcher, the system can prepare, if the subject performs their own reset.

Resetting also helps administration of the networking site and helps users when there are fewer accounts tied to one offending user.

In some implementations, users still retain their profile, existing matches, and likes in their “Likes You” tab.

The availability of a reset might be limited to a predetermined period (e.g., once every 30 days) to reduce dilution of the recommendation system. If a user resets again (e.g., more than 30 days later), the system can reset his or her profile and interactions from the last time they used the feature, rather than from the original profile and interactions.

A reset can involve, from a user perspective, treating certain (notably, all rejected) likes and ratings like they did not historically occur. However, from the system perspective, the reset might still retain the historical information for some purposes, such as training algorithms or monitoring performance.

In some implementations, the system can identify a poorly performing photograph. Thus, upon the occurrence of a reset, the system can recommend updating the photograph. In various implementations of the reset feature, the system can recommend updating other portions of the user's profile, such as the user's prompts and preferences.

Some implementations of the networking site can encourage users to update their profile (pics, prompts, preferences) after the profile reset. These profile updates will reduce the risk of subjects being annoyed that they are seeing the same people again and help the person resetting show the best, new, version of themselves.

In some implementations, if a searcher sends a skip to a subject who was displayed to the searcher or who sent a like to the searcher, the searcher can see the subject again after the searcher's profile reset. The subject in such a scenario generally cannot see the searcher again, unless the subject performs their own profile reset.

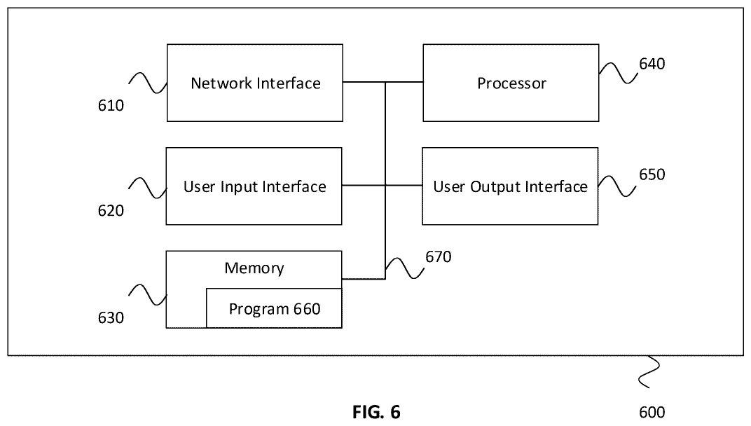

FIG. 6 illustrates a computing device 600, according to an implementation of the present disclosure. The computing device 600 is an example of an apparatus by which users (e.g., depending on context, the first user, the second user, the searcher, and the subject) interact with the networking site. In many such implementations, the computing device 600 is implemented by a smartphone. Further, the computing device 600 is an apparatus at least partially implementing the networking site. In many such implementations, the computing device 600 is implemented by a server.

The computing device 600 can include a network interface 610, a user input interface 620, a memory 630, a program 660, a processor 640, a user output interface 650, and a bus 670.

Although illustrated within a single housing, the computing device 600 can be distributed across plural housings or sub-systems that cooperate in executing program instructions. In some implementations, the computing device 600 can include one or more blade server devices, standalone server devices, personal computers (including desktop computers, laptop computers, and tablet computers), routers, hubs, switches, bridges, firewall devices, intrusion detection devices, mainframe computers, network-attached storage devices, smartphones and other mobile telephones, and other computing devices. The system executes the Windows OS, macOS, Linux, or Android in many implementations, and the system hardware can be configured according to a Symmetric Multi-Processing (SMP) architecture or a Non-Uniform Memory Access (NUMA) architecture.

The network interface 610 provides one or more communication connections and/or one or more devices that allow for communication between the computing device 600 and other computing systems (not shown) over a communication network, collection of networks (not shown), or the air, to support the operations for resetting recommendations while partially maintaining a profile and matches, outlined herein. The network interface 610 can communicate using various networks (including both internal and external networks) such as near-field communications (NFC), Wi-FiTM, Bluetooth, Ethernet, cellular (e.g., 3G, 4G, 5G), white space, 802.11x, satellite, Bluetooth, LTE, GSM/HSPA, CDMA/EVDO, DSRC, CAN, GPS, facsimile, or any other wired or wireless interface. Other interfaces can include physical ports (e.g., Ethernet, USB, HDMI, etc.), interfaces for wired and wireless internal subsystems, and the like. Similarly, nodes and user equipment (e.g., mobile devices) of the system can also include suitable interfaces for receiving, transmitting, and/or otherwise communicating data or information in a network environment.

The user input interface 620 can receive one or more inputs from a human. The user input interface 620 can be or include a mouse, a touchpad, a keyboard, a touchscreen, a trackball, a camera, a microphone, a joystick, a game controller, a scanner, or any other input device.

The memory 630, also termed a “storage,” can include or be one or more computer-readable storage media readable by the processor 640 and that store software. The memory 630 can be implemented as one storage device or across multiple co-located or distributed storage devices or sub-systems. The memory 630 can include additional elements, such as a controller, that communicate with the processor 640. The memory 630 can also include storage devices and/or sub-systems on which data and/or instructions are stored. The computing device 600 can access one or more of the storage resources to access information to carry out any of the processes indicated in this disclosure and, in particular, FIGS. 2 and 4-5. In various implementations, the memory 630 stores the program 660 to execute at least a portion of the algorithms illustrated in FIGS. 2 and 4-5. Further, the program 660, when executed by the computing device 600 generally and/or the processor 640 specifically, can direct, among other functions, performance of the operations of resetting recommendations while partially maintaining a profile and matches, as described herein.

The memory 630 can be or include a read-only memory (ROM), a programmable ROM (PROM), an erasable PROM (EPROM), an electrically erasable PROM (EEPROM), a random-access memory (RAM), a dynamic RAM (DRAM), a static RAM (SRAM), a field programmable gate array (FPGA), a hard drive, a cache memory, a flash memory, a removable disk, or a tape reel. The memory 630 can be or include resistive RAM (RRAM) or a magneto-resistive RAM (MRAM). The information being tracked, sent, received, or stored in the communication system can be provided in any database, register, table, cache, queue, control list, or storage structure, based on particular implementations, all of which could be referenced in any suitable timeframe.

The processor 640 (e.g., a processing unit) can be or include one or more hardware processors and/or other circuitry that retrieve and execute software, especially the program 660, from the memory 630. In some implementations, the processor 640 is or includes a Graphics Processing Unit (GPU).

The processor 640 can have any register size, such as a 32-bit register or a 64-bit register, among others. The processor 640 can include multiple cores. Implementations of the processor 640 are not limited to any particular number of threads. The processor 640 can be fabricated by any process technology, such as 14 nm process technology.

The processor 640 can be implemented within one processing device, chip, or package and can also be distributed across multiple processing devices, chips, packages, or sub-systems that cooperate. In select implementations, these devices, chips, packages, or sub-systems can include the program 660, thus implementing the program 660 as a module.

The user output interface 650 outputs information to a human user. The user output interface 650 can be or include a display (e.g., a screen), a touchscreen, speakers, a printer, or a haptic feedback unit. In many implementations, the user output interface 650 can be combined with the user input interface 620. For example, some such implementations include a touchscreen, a headset including headphones and a microphone, or a joystick with haptic feedback.

In implementations including multiple computing devices, a server of the system or, in a serverless implementation, a peer can use one or more communications networks that facilitate communication among the computing devices to achieve the operations for resetting recommendations while partially maintaining a profile and matches, as outlined herein. For example, the one or more communications networks can include or be a cellular network, a local area network (LAN), and/or a wide area network (WAN) that facilitate communication among the computing devices. One or more direct communication links can be included between the computing devices. In addition, in some cases, the computing devices can be installed at geographically distributed locations. In other cases, the multiple computing devices can be installed at one geographic location, such as a server farm or an office.

As used herein, the terms “storage media” or “computer-readable storage media” can refer to non-transitory storage media, such as non-limiting examples of a hard drive, a memory chip, an ASIC, and cache memory, and to transitory storage media, such as carrier waves or propagating signals.

Aspects of the system can be implemented in various manners, e.g., as a method, a system, a computer program product, or one or more computer-readable storage media). Accordingly, aspects of the present disclosure can take the form of a hardware implementation, a software implementation (including firmware, resident software, or micro-code) or an implementation combining software and hardware aspects that can generally be referred to herein as a “module” or a “system.” Functions described in this disclosure can be implemented as an algorithm executed by one or more hardware processing units, e.g., the processor 640. In various embodiments, different operations and portions of the operations of the algorithms described can be performed by different processing units. In some implementations, the operations can be achieved by reciprocating software in any of the devices used by the first and second users (e.g., smartphones) and/or the networking site (e.g., a server). Furthermore, aspects of the present disclosure can take the form of a computer program product embodied in one or more computer-readable media having computer-readable program code embodied, e.g., encoded or stored, thereon. In various implementations, such a computer program can, for example, be downloaded (or updated) to existing devices and systems or be stored upon manufacture of these devices and systems.

Any suitable permutation can be applied to a physical implementation, including the design of the communications network in which the system is implemented. In one embodiment, the bus 670 can share hardware resources with the memory 630 and the processor 640. In this alternative implementation, the computing device 600 be provided with separate hardware resources including one or more processors and memory elements.

In example implementations, various other components of the computing device 600 can be installed in different physical areas or can be installed as single units.

The communication system can be configured to facilitate communication with machine devices (e.g., vehicle sensors, instruments, electronic control units (ECUs), embedded devices, actuators, displays, etc.) through the bus 670. Other suitable communication interfaces can also be provided for an Internet Protocol (IP) network, a user datagram protocol (UDP) network, or any other suitable protocol or communication architecture enabling network communication with machine devices.

The innovations in this detailed description can be implemented in a multitude of different ways, for example, as defined and covered by the claims and/or select examples. In the description, reference is made to the drawings where like reference numerals can indicate identical or functionally similar elements. Elements illustrated in the drawings are not necessarily drawn to scale. Additionally, certain implementations can include more elements than illustrated in a drawing and/or a subset of the elements illustrated in a drawing. Further, some implementations can incorporate a suitable combination of features from two or more drawings.

The disclosure describes various illustrative implementations and examples for implementing the features and functionality of the present disclosure. The components, arrangements, and/or features are described in connection with various implementations and are merely examples to simplify the present disclosure and are not intended to be limiting. In the development of actual implementations, implementation-specific decisions can be made to achieve specific goals, including compliance with system, business, and/or legal constraints, which can vary from one implementation to another. Additionally, while such a development effort might be complex and time-consuming, it would be a routine undertaking for those of ordinary skill in the art having the benefit of this disclosure.

The systems, methods and devices of this disclosure have several innovative aspects, no one of which is solely responsible for the attributes disclosed herein. Some objects or advantages might not be achieved by implementations described herein. Thus, for example, certain implementations can operate in a manner that achieves or optimizes one advantage or group of advantages as taught herein and not other objects or advantages as taught or suggested herein.

In one example implementation, electrical circuits of the drawings can be implemented on a board of an associated electronic device. The board can be a general circuit board that can hold various components of the internal electronic system of the electronic device and, further, provide connectors for other peripherals. More specifically, the board can provide the electrical connections by which other components of the system can communicate electrically. Any processors (inclusive of digital signal processors, microprocessors, supporting chipsets, etc.) and computer-readable, non-transitory memory elements can be coupled to the board based on configurations, processing demands, and computer designs. Other components such as external storage, additional sensors, controllers for audio/video display, and peripheral devices can be attached to the board as plug-in cards, via cables, or integrated into the board itself. In various implementations, the functionalities described herein can be implemented in emulation form as software or firmware running within one or more configurable (e.g., programmable) elements arranged in a structure that supports these functions. A non-transitory, computer-readable storage medium can include instructions to allow one or more processors to carry out the emulation.

In another example implementation, the electrical circuits of the drawings can be implemented as stand-alone modules (e.g., a device with associated components and circuitry configured to perform a specific application or function) or implemented as plug-in modules into application specific hardware of electronic devices. Implementations of the present disclosure can be readily included in a system-on-chip (SOC) package. An SOC represents an integrated circuit (IC) that integrates components of a computer or other electronic system into one chip. The SOC can contain digital, analog, mixed-signal, and often radio frequency functions on one chip substrate. Other implementations can include a multi-chip-module (MCM), with a plurality of separate ICs located within one electronic package and that interact through the electronic package. In various other implementations, the processors can be implemented in one or more silicon cores in Application Specific Integrated Circuits (ASICs), Field Programmable Gate Arrays (FPGAs), programmable array logic (PAL), generic array logic (GAL), and other semiconductor chips.

The specifications, dimensions, and relationships outlined herein (e.g., the number of processors and logic operations) have been offered for non-limiting purposes of example and teaching. For example, various modifications and changes can be made to the arrangements of components. The description and drawings are, accordingly, to be regarded in an illustrative sense, not in a restrictive sense.

The numerous examples provided herein described interaction in terms of two, three, or more electrical components for purposes of clarity and example. The system can be consolidated in any manner. Along similar design alternatives, the illustrated components, modules, and elements of the drawings can be combined in various possible configurations within the scope of this disclosure. In certain cases, one or more of the functionalities of a given set of flows might be more clearly described by referencing a limited number of electrical elements. The electrical circuits of the drawings are readily scalable and can accommodate many components, as well as more complicated/sophisticated arrangements and configurations. Accordingly, the provided examples do not limit the scope or inhibit the teachings of the electrical circuits as potentially applied to a myriad of other architectures.

In this disclosure, references to various features (e.g., elements, structures, modules, components, steps, operations, characteristics, etc.) included in “one implementation,” “example implementation,” “an implementation,” “another implementation,” “select implementations,” “some implementations,” “various implementations,” “other implementations,” “alternative implementation,” and the like are intended to mean that any such features can be included in one or more implementations of the present disclosure and might or might not necessarily be combined in the same implementations. Some operations can be deleted or omitted where appropriate, or these operations can be modified or changed considerably. In addition, the timing of these operations can be altered considerably. The preceding operational flows have been offered for purposes of example and discussion. Implementations described herein provide flexibility in that any suitable arrangements, chronologies, configurations, and timing mechanisms can be provided.

### EXAMPLES

In Example M1, a method includes forming a first recommendation, for a first user of a networking site, of a second user of the networking site, at least in part based on a first profile of a first account of the first user on the networking site and a second profile of a second account of the second user on the networking site; performing a first interaction between the first account and the second account; receiving a request to reset the first profile; producing an updated profile by maintaining a first portion of the first profile and resetting a second portion of the first profile; and forming a second recommendation, for the first user, of the second user, at least in part based on the updated profile.

Example M2 is the method of Example M1, wherein the first interaction is defined by the first user skipping the second profile.

Example M3 is the method of Example M1 or M2, further comprising: performing a second interaction between the first account and the second account, wherein the first interaction is defined by the first user sending a like regarding at least a portion of the second profile, and the second interaction is defined by the second user rejecting the like.

Example M4 is the method of any of Examples M1-M3, further comprising: performing a second interaction between the first account and the second account, wherein the first interaction is defined by the second user sending a like regarding at least a portion of the first profile, and the second interaction is defined by the first user rejecting the like.

Example M5 is the method of any of Examples M1-M4, wherein the first portion includes at least one photograph of the first user.

Example M6 is the method of any of Examples M1-M5, further comprising: updating the first profile with a third portion, wherein the second recommendation is at least in part based on the third portion.

Example M7 is the method of any of Examples M1-M6, further comprising: promoting the updated profile on the networking site.

In Example C1, a non-transitory, computer-readable medium is encoded with executable instructions that, when executed by a processing unit, perform operations comprising: forming a first recommendation, for a first user of a networking site, of a second user of the networking site, at least in part based on a first profile of a first account of the first user on the networking site and a second profile of a second account of the second user on the networking site; performing a first interaction between the first account and the second account; receiving a request to reset the first profile; producing an updated profile by maintaining a first portion of the first profile and resetting a second portion of the first profile; and forming a second recommendation, for the first user, of the second user, at least in part based on the updated profile.

Example C2 is the medium of Example C1, wherein the first interaction is defined by the first user skipping the second profile.

Example C3 is the medium of Example C1 or C2, the operations further comprising: performing a second interaction between the first account and the second account, wherein the first interaction is defined by the first user sending a like regarding at least a portion of the second profile, and the second interaction is defined by the second user rejecting the like.

Example C4 is the medium of any of Examples C1-C3, the operations further comprising: performing a second interaction between the first account and the second account, wherein the first interaction is defined by the second user sending a like regarding at least a portion of the first profile, and the second interaction is defined by the first user rejecting the like.

Example C5 is the medium of any of Examples C1-C4, wherein the first portion includes at least one photograph of the first user.

Example C6 is the medium of any of Examples C1-C5, the operations further comprising: updating the first profile with a third portion, wherein the second recommendation is at least in part based on the third portion.

Example C7 is the medium of any of Examples C1-C6, the operations further comprising: promoting the updated profile on the networking site.

In Example A1, an apparatus includes a processor configured to form a first recommendation, for a first user of a networking site, of a second user of the networking site, at least in part based on a first profile of a first account of the first user on the networking site and a second profile of a second account of the second user on the networking site, and to perform a first interaction between the first account and the second account; and a network interface that receives a request to reset the first profile, wherein the processor further is configured to produce an updated profile by maintaining a first portion of the first profile and resetting a second portion of the first profile and to form a second recommendation, for the first user, of the second user, at least in part based on the updated profile.

Example A2 is the apparatus of Example A1, wherein the first interaction is defined by the first user skipping the second profile.

Example A3 is the apparatus of Example A1 or A2, wherein the processor further is configured to perform a second interaction between the first account and the second account, the first interaction is defined by the first user sending a like regarding at least a portion of the second profile, and the second interaction is defined by the second user rejecting the like.

Example A4 is the apparatus of any of Examples A1-A3, wherein the processor further is configured to perform a second interaction between the first account and the second account, the first interaction is defined by the second user sending a like regarding at least a portion of the first profile, and the second interaction is defined by the first user rejecting the like.

Example A5 is the apparatus of any of Examples A1-A4, wherein the first portion includes at least one photograph of the first user.

Example A6 is the apparatus of any of Examples A1-A5, wherein the processor further is configured to update the first profile with a third portion, and the second recommendation is at least in part based on the third portion.

Example A7 is the apparatus of any of Examples A1-A6, wherein the processor further is configured to promote the updated profile on the networking site.

In Example F1, an apparatus includes means for forming a first recommendation, for a first user of a networking site, of a second user of the networking site, at least in part based on a first profile of a first account of the first user on the networking site and a second profile of a second account of the second user on the networking site; means for performing a first interaction between the first account and the second account; means for receiving a request to reset the first profile; means for producing an updated profile by maintaining a first portion of the first profile and resetting a second portion of the first profile; and means for forming a second recommendation, for the first user, of the second user, at least in part based on the updated profile.

Example F2 is the apparatus of Example F1, wherein the first interaction is defined by the first user skipping the second profile.

Example F3 is the apparatus of Example F1 or F2, further comprising: means for performing a second interaction between the first account and the second account, wherein the first interaction is defined by the first user sending a like regarding at least a portion of the second profile, and the second interaction is defined by the second user rejecting the like.

Example F4 is the apparatus of any of Examples F1-F3, further comprising: means for performing a second interaction between the first account and the second account, wherein the first interaction is defined by the second user sending a like regarding at least a portion of the first profile, and the second interaction is defined by the first user rejecting the like.

Example F5 is the apparatus of any of Examples F1-F4, wherein the first portion includes at least one photograph of the first user.

Example F6 is the apparatus of any of Examples F1-F5, further comprising: means for updating the first profile with a third portion, wherein the second recommendation is at least in part based on the third portion.

Example F7 is the apparatus of any of Examples F1-F6, further comprising: means for promoting the updated profile on the networking site.

We claim:

1. A method, comprising:
forming a first recommendation, for a first user of a networking site, of a second user of the networking site, at least in part based on a first profile of a first account of the first user on the networking site and a second profile of a second account of the second user on the networking site;
performing a first interaction between the first account and the second account;
receiving a request to reset the first profile;
producing an updated profile by maintaining a first portion of the first profile and resetting a second portion of the first profile; and
forming a second recommendation, for the first user, of the second user, at least in part based on the updated profile.

2. The method of claim 1, wherein the first interaction is defined by the first user skipping the second profile.

3. The method of claim 1, further comprising:
performing a second interaction between the first account and the second account, wherein the first interaction is defined by the first user sending a like regarding at least a portion of the second profile, and the second interaction is defined by the second user rejecting the like.

4. The method of claim 1, further comprising:
performing a second interaction between the first account and the second account, wherein the first interaction is defined by the second user sending a like regarding at least a portion of the first profile, and the second interaction is defined by the first user rejecting the like.

5. The method of claim 1, wherein the first portion includes at least one photograph of the first user.

6. The method of claim 1, further comprising:
updating the first profile with a third portion, wherein the second recommendation is at least in part based on the third portion.

7. The method of claim 1, further comprising:
promoting the updated profile on the networking site.

8. A non-transitory, computer-readable medium encoded with executable instructions that, when executed by a processing unit, perform operations comprising:
forming a first recommendation, for a first user of a networking site, of a second user of the networking site, at least in part based on a first profile of a first account of the first user on the networking site and a second profile of a second account of the second user on the networking site;
performing a first interaction between the first account and the second account;
receiving a request to reset the first profile;
producing an updated profile by maintaining a first portion of the first profile and resetting a second portion of the first profile; and
forming a second recommendation, for the first user, of the second user, at least in part based on the updated profile.

9. The medium of claim 8, wherein the first interaction is defined by the first user skipping the second profile.

10. The medium of claim 8, the operations further comprising:
performing a second interaction between the first account and the second account, wherein the first interaction is defined by the first user sending a like regarding at least a portion of the second profile, and the second interaction is defined by the second user rejecting the like.

11. The medium of claim 8, the operations further comprising:
performing a second interaction between the first account and the second account, wherein the first interaction is defined by the second user sending a like regarding at least a portion of the first profile, and the second interaction is defined by the first user rejecting the like.

12. The medium of claim 8, wherein the first portion includes at least one photograph of the first user.

13. The medium of claim 8, the operations further comprising:
updating the first profile with a third portion, wherein the second recommendation is at least in part based on the third portion.

14. The medium of claim 8, the operations further comprising:
promoting the updated profile on the networking site.

15. An apparatus, comprising:
a processor configured to form a first recommendation, for a first user of a networking site, of a second user of the networking site, at least in part based on a first profile of a first account of the first user on the networking site and a second profile of a second account of the second user on the networking site, and to perform a first interaction between the first account and the second account; and
a network interface that receives a request to reset the first profile, wherein
the processor further is configured to produce an updated profile by maintaining a first portion of the first profile and resetting a second portion of the first profile and to form a second recommendation, for the first user, of the second user, at least in part based on the updated profile.

16. The apparatus of claim 15, wherein the first interaction is defined by the first user skipping the second profile.

17. The apparatus of claim 15, wherein the processor further is configured to perform a second interaction between the first account and the second account, the first interaction is defined by the first user sending a like regarding at least a portion of the second profile, and the second interaction is defined by the second user rejecting the like.

18. The apparatus of claim 15, wherein the processor further is configured to perform a second interaction between the first account and the second account, the first interaction is defined by the second user sending a like regarding at least a portion of the first profile, and the second interaction is defined by the first user rejecting the like.

19. The apparatus of claim 15, wherein the first portion includes at least one photograph of the first user.

20. The apparatus of claim 15, wherein the processor further is configured to update the first profile with a third portion, and the second recommendation is at least in part based on the third portion.
